(19) United States
(12) Patent Application Publication
(10) Pub. No.: US 2015/0263966 A1
(43) Pub. Date: Sep. 17, 2015

(54) Methods and apparatus for cycle accurate time stamping at line rate throughput

(71) Applicant: Anthony Blake, Hamilton West (NZ)

(72) Inventor: Anthony Blake, Hamilton West (NZ)

(73) Assignee: Anthony Blake, Hamilton West (NZ)

(21) Appl. No.: 14/205,319

(22) Filed: Mar. 11, 2014

(51) Int. Cl. H04L 12/841; H04L 12/875

(52) U.S. Cl. CPC H04L 47/28; H04L 47/562

(57) ABSTRACT

Methods and apparatus may be used to provide cycle accurate time stamping at line rate throughput. This may be done, for example, to allow a NTP processing device to process timing requests at line rate throughput without packets being dropped and/or without overflowing a buffer. The NTP processing device may be able to handle timing request such as ARP request, NTP request, a combination thereof, or the like. The NTP processing device may be able to receive and process timing requests, such as NTP requests or ARP requests, at a line rate throughput. The NTP processing device may be able to generate timing responses, such as NTP responses or ARP responses, at line rate throughput.

### BACKGROUND

Accurate time information may be needed to adjust the clocks of computers. The time information may also be needed to coordinate time between computers in a network. A network time protocol (NTP) may be used for this purpose. NTP is a networking protocol for clock synchronization between computer systems over a packet-switched, variable-latency data network. NTP provides coordinated universal time (UTC).

NTP may allow a computer to discipline or synchronize its clock by requesting a NTP response from an NTP server. However, current NTP servers may become overloaded with requests as current NTP servers cannot process NTP request as quickly as they are received. For example, current NTP servers are unable to unable to provide accurate NTP timestamps at line rate throughput such as at the wire-speed of Gigabit Ethernet. Because the NTP request cannot be processed as quickly as they are received, current NTP servers may drop packets and may experience buffer overflows.

### SUMMARY

Disclosed herein are methods and apparatus for cycle accurate time stamping at line rate throughput. This may be done, for example, to allow a NTP processing device to process timing requests at line rate throughput without packets being dropped and/or without overflowing a buffer. The NTP processing device may be able to handle a timing request such as an ARP request, an NTP request, a combination thereof, or the like. The NTP processing device may be able to receive and process timing requests, such as NTP requests or ARP requests, at a line rate throughput. The NTP processing device may be able to generate timing responses, such as NTP responses or ARP responses, at line rate throughput.

An apparatus for providing a cycle accurate timestamp at line rate throughput may be provided. The apparatus may include a processor that may be configured to perform a number of actions. For example, the processor may receive a timing request at a line rate. A transmit timestamp may be calculated. The transmit timestamp may indicate when a timing response may be sent. The timing response may be generated at the line rate throughput such that an incoming data packet may be prevented from being dropped. The timing response may include the transmit timestamp. The timing response may be sent at the time indicated by the transmit timestamp.

An apparatus for responding to a timing request may be provided. The timing request may be a request to discipline a clock. The apparatus may provide cycle accurate timestamps at line rate throughput. The apparatus may include a processor that may be configured to perform a number of actions. For example, the processor may calculate a transmit timestamp. The transmit timestamp may indicate when a timing response may be sent. The timing response may be generated using a data path that can be used to generate an address response. The timing response may be used to discipline a clock. The timing response may be sent at the time indicated by the transmit timestamp.

An apparatus for disciplining a clock may be provided. The apparatus may provide cycle accurate timestamps at a line rate throughput. The apparatus may include a processor that may be configured to perform a number of actions. For example, the processor may receive a request to discipline a clock. A transmit timestamp may be calculated. The transmit timestamp may indicate when a response may be sent. A response may be generated at the line rate through put such that timestamp jitter greater than a clock cycle may be prevented. The response may be used to discipline the clock.

The Summary is provided to introduce a selection of concepts in a simplified form that are further described in the Detailed Description. This Summary is not intended to identify key or essential features of the claimed subject matter, nor is it intended to be used to limit the scope of the claimed subject matter. Furthermore, the claimed subject matter is not limited to any limitations that solve any or all disadvantages noted in any part of this disclosure.

### BRIEF DESCRIPTION OF THE DRAWINGS

Methods and apparatus for cycle accurate time stamping at line rate throughput are further described with the reference to the following drawings:

FIG. 1A illustrates an example of a Network Time Protocol (NTP) processing device that may process timing requests, address resolution requests, a combination thereof, or the like.

FIG. 1B illustrates an example of a computing environment that may be used to implement cycle accurate time stamping at a line rate throughput.

FIG. 2 illustrates an example of a hierarchy that may be used for NTP.

FIG. 3 illustrates an example of a network system that may use a protocol to discipline a clock such as NTP.

FIG. 4 illustrates an example of an NTP interaction that may allow a clock to be disciplined.

FIG. 5A illustrates an example of an Ethernet data packet structure that may include an NTP packet.

FIG. 5B illustrates an example of a data packet that may allow a clock to be disciplined.

FIG. 6 illustrates an example method for responding to an address resolution request and/or a timing request.

FIG. 7 illustrates an example apparatus for responding to a timing request an/or address resolution request.

FIG. 8 illustrates an example apparatus for creating timestamps to be used for a timing response.

FIG. 9 illustrates an example apparatus for generating a timing response and/or an address resolution response.

### DETAILED DESCRIPTION OF ILLUSTRATIVE EMBODIMENTS

A detailed description of illustrative embodiments will be described with reference to the Figures. Although this description provides a detailed example of possible implementations, the details are intended to be exemplary and do not limit the scope of the application.

The internal clocks of several computers may differ and may need to be disciplined. Even when initially set accurately, clocks may differ after some amount of time due to clock drift as clocks may count time at slightly different rates. In a distributed system, such as a network, disciplining clocks may be complex as a global time may not be known.

The network timing protocol (NTP) may be used to discipline the internal clocks of several computers. NTP may use a layered client-server architecture that may use user datagram protocol (UDP) messages. NTP may allow clocks to be disciplined by exchanging timestamps using packets. NTP may allow a computer to select and compare clocks. NTP may allow multiple time synchronization probes to be combined over a period of time to produce quality timing and an estimate of clock drifts. NTP may allow a clock of a computer to remain disciplined when there may be a loss of connectivity to other clocks.

To discipline its clock with a server, an NTP client may calculate a round-trip delay time, δ, and an offset, θ. A round-trip delay, δ, may be calculated as follows:

δ=(t₃−t₀)−(t₂−t₁)

t₀ may be a timestamp from the client that may indicate when the client sent a timing request. t₁ may be a timestamp from the server that may indicate when the server received the timing request from the client. t₂ may be a timestamp from the server that may indicate when the server sent a timing response. t₃ may be a timestamp from the client that may indicate when the client received the timing response. (t₃−t₀) may indicate the time that may have passed on the client side between the sending of the request and the receipt of the response. (t₂−t₃) may indicate the time it may have taken the server to send the response.

The offset, θ, may be calculated as follows:

$$θ = \frac{( {t}_{1} - {t}_{0} ) + ( {t}_{2} - {t}_{3} )}{2}$$

An apparatus for providing a cycle accurate timestamp at line rate throughput may be provided. The line rate may be the rate at which data may be sent and/or received over a physical connection. The apparatus may include a processor that may be configured to perform a number of actions. For example, the processor may be configured to receive a timing request at a line rate. The timing request may include a receive timestamp that may indicate when the timing request may have been received. The timing request may be a NTP request, a PTP request, or the like. A transmit timestamp may be calculated. The transmit timestamp may indicate when a timing response may be sent. The timing response may be generated at the line rate throughput such that an incoming data packet may be prevented from being dropped, a buffer may be prevented from overflowing, timestamp jitter may be prevented, a combination thereof, or the like. The incoming data packet may be a timing request (e.g. NTP request, PTP request, etc.) or an address resolution request (e.g. ARP request, NDP request, etc.). The timing response may include the transmit timestamp. The timing response may be sent at the time indicated by the transmit timestamp.

An apparatus for responding to a timing request may be provided. The timing request may be a request to discipline a clock. The timing request may be a NTP request, a PTP request, or the like. The apparatus may provide cycle accurate timestamps at line rate throughput. The apparatus may include a processor that may be configured to perform a number of actions. For example, the processor may be configured to calculate a transmit timestamp. The transmit timestamp may indicate when a timing response may be sent. A timing response may be generated using a data path that can be used to generate an address response. The address response may be an ARP response, a neighbor discovery protocol (NDP) response, or the like. The data path may prevent an incoming packet from being dropped while operating at the line rate, may prevent a buffer receiving an incoming packet from overflowing, may prevent timestamp jitter, a combination thereof, or the like. The timing response may be used to discipline a clock. The timing response may be a NTP response, a PTP response, or the like. The timing response may be sent at the time indicated by the transmit timestamp.

An apparatus for disciplining a clock may be provided. The apparatus may provide cycle accurate timestamps at a line rate throughput. The apparatus may include a processor that may be configured to perform a number of actions. For example, the processor may be configured to receive a request to discipline a clock. The request may include a receive timestamp that may indicate when the request was received. A transmit timestamp may be calculated. The transmit timestamp may indicate when a response may be sent. The transmit timestamp may be a cycle accurate timestamp. A response may be generated at the line rate such that timestamp jitter greater than a clock cycle may be prevented, an incoming data packet may be prevented from being dropped, a buffer may be prevented from overflowing, a combination thereof, or the like. The response may be generated using a data path that may be used to generate an address response. The response may be used to discipline a clock. The response may include the receive timestamp, the transmit timestamp, an originate timestamp that may indicate when a clock was last disciplined, a reference timestamp that may be a timestamp from a reference clock, a combination thereof, or the like. The response may be sent.

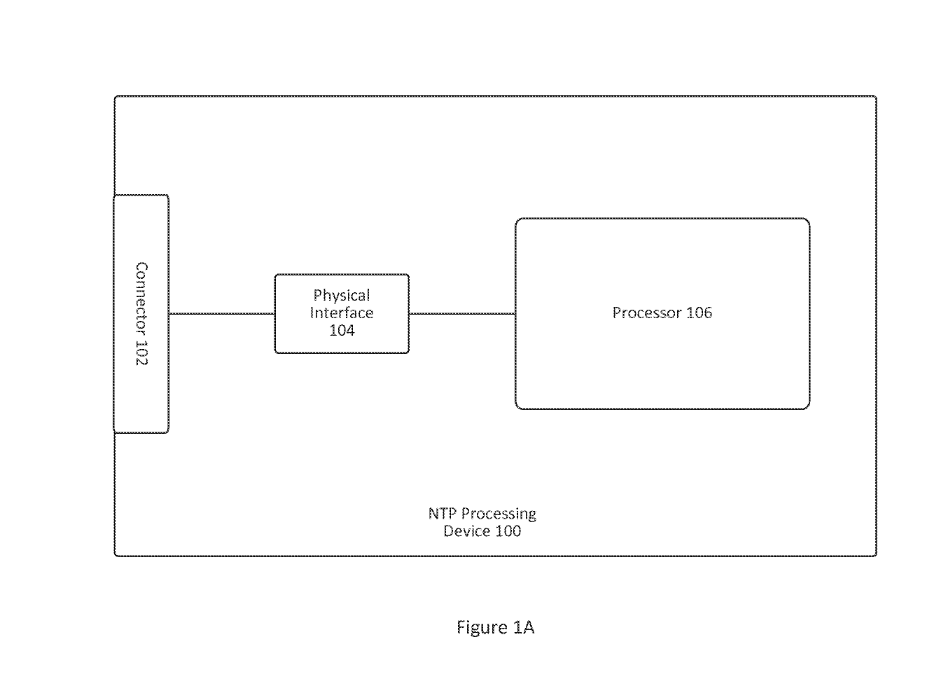

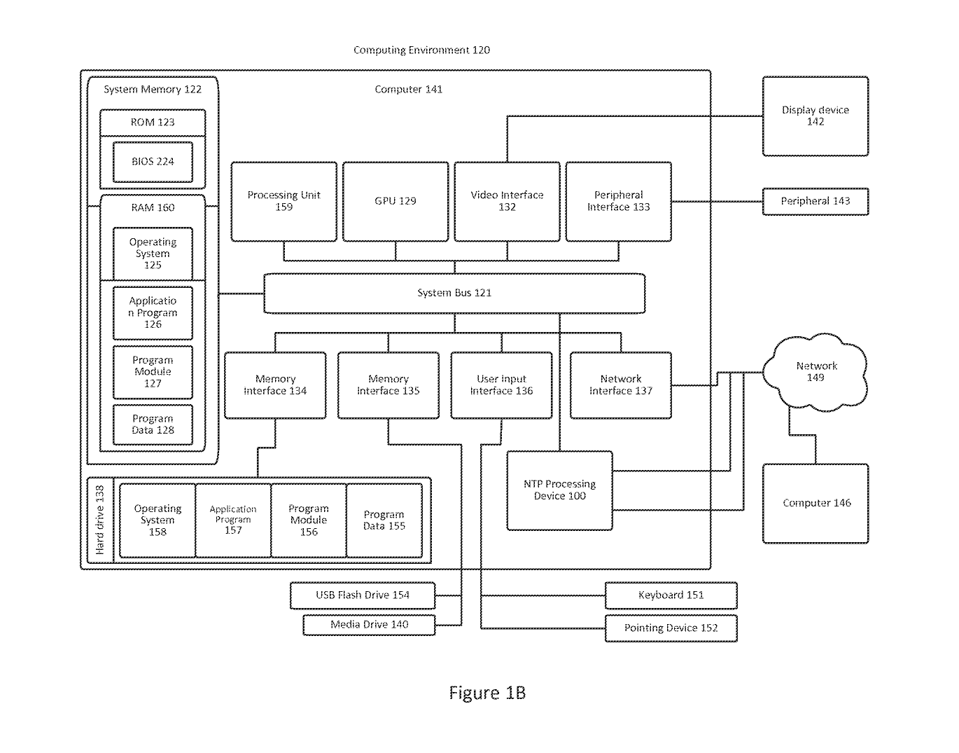

FIG. 1A illustrates an example of a Network Time Protocol (NTP) processing device. The NTP processing device may be NTP processing device 100. NTP processing device may be used to provide a NTP server and may be able to send timing responses at the same rate it may receive timing requests. For example, NTP processing device 100 may be able to receive timing requests at line rate throughput via a first Gigabit Ethernet and be able to transmit timing requests at line rate throughput via a second Gigabit Ethernet. NTP processing device may be able to handle address response protocol (ARP) requests and NTP requests using the same data path and may be able to handle those requests at line rate throughput. For example, NTP processing device 100 may be able to respond to ARP requests and/or NTP requests at line rate throughput without dropping packets or overflowing a buffer. NTP processing device 100 may be able to prevent timestamp jitter greater than the transmit clock cycle of a Gigabit Ethernet when experiencing full traffic.

NTP processing device 100 may include processor 106. Processor 106 may be a processor, a specialized processor, a field-programmable gate array (FPGA), or the like. Processor 106 may be connected to physical interface 104. Processor 106 may communicate with a network using physical interface 104 and connector 102. Although not shown, processor 106 may use physical interface 104 to communicate with multiple connectors. For example, processor 106 may communicate with a first connector to receive data from a network and may communicate with a second connector to send data to a network. Processor 106 may send a packet to physical interface 104 that may be translated into a bit stream that may be sent to a network via connector 102.

Processor 106 may provide cycle accurate time stamping at line rate throughput. In a timing protocol, such as NTP, time may be passed from one time source to another to discipline a clock. For example, time from a reference clock may be passed to a server to allow the server to discipline a server clock. The server clock may pass time to a client to allow the client to discipline a client clock. A timing request and a timing response may be used to synchronize time between the reference clock and the server, the server and the client, the reference clock and the client, or the like.

Processor 106 may allow NTP processing device 100 to receive a timing request such as a NTP timing request. The timing request may be a request to adjust the time of a client clock to align with the time of a server clock. The server clock may be a clock that may be connected to NTP processing device 100. For example, the server clock may be a clock that may belong to a computer that may be using NTP processing device 100. The timing request may include a client request timestamp. The client request timestamp may indicate when the client sent a timing request.

When processor 106 receives the timing request, processor 106 may stamp the timing request with a receive timestamp. The receive timestamp may indicate when the processor received the timing request from the client. Processor 106 may generate a timing response. The timing response may allow the client to discipline the client clock such that the client clock may align with the time of the server clock. The timing response may include the receive timestamp, a reference timestamp, a originate timestamp, and a transmit timestamp. The reference timestamp may indicate when the clock was last disciplined. The originate timestamp may indicate when the client may have sent the request. For example, the originate timestamp may be the client request timestamp. The transmit timestamp may indicate when the server may transmit the timing response to the client. The server may send the timing response to the client.

The client may receive the timing response and may stamp the timing response with a client arrival timestamp. The client arrival timestamp may indicate when the client may have received the timing response. The client may use the timing response to discipline the client clock such that it may align with the time of the server clock. For example, the client may calculate a round trip time and an offset and may use the roundtrip time and/or the offset to discipline the client clock.

Processor 106 may provide cycle accurate time stamping at line rate throughput. For example, processor 106 may be able to timestamp packets at the maximum rate at which a network may deliver the packets to the line connected to connector 102.

Processor 106 may be able to process packets as fast as they are received without dropping packets or overflowing a buffer. For example, processor 106 may process packets at or faster than a line rate throughput. Processor 106 may include a data pipeline that may allow for an ARP packet or a NTP packet to be processed in a similar amount of time. Processor 106 may be able to process ARP packets and NTP packets using the same data path. Processor 106 may be able to switch from processing an ARP packet to processing an NTP packet without affecting the rate at which packets may be received and/or processed. For example, processor 106 may continue to receive packets a line rate throughput without dropping packets while switching from processing a NTP packet to processing an ARP packet.

Processor 106 may determine a receive timestamp for the NTP response that may indicate when NTP processing device 100 may have received a NTP request. The receive timestamp may indicate when NTP processing device may have received the NTP request. The receive timestamp may be determined using a timestamp from a clock that may belong to NTP processing device 100. The clock may or may not be within processor 106. Processor 106 may determine a timestamp may set a receive timestamp for a NTP response as the determined timestamp. The determined timestamp may reflect when processor 106 may have received the NTP request. The determined timestamp may include a time offset that may account for a data processing delay such as the time that elapsed while determining a timestamp, the time that elapsed while retrieving a timestamp, the time that elapsed for the NTP request to travel to processor 106, a combination thereof, or the like. For example, processor 106 may be able to determine the amount of time that may have elapsed from when a request was received by connector 102 and when the request was received by processor 106. Processor 106 may set a time offset to the determined amount of time. Processor 106 may retrieve a timestamp that may reflect a current time, may determine a receive timestamp by subtracting the time offset from the current time, and may include the receive timestamp in an NTP response.

Processor 106 may determine a transmit timestamp for the NTP response. The transmit timestamp may indicate when the NTP response may be sent. Processor 106 may determine a timestamp and may set the determined timestamp as transmit timestamp. The determined timestamp may reflect when NTP processing device 100 may send the NTP response. The determine timestamp may include a time offset that may account for a data processing delay such as the time that elapsed while determining a timestamp, the time that may elapse before the NTP response may be sent, the time that may elapse while sending the response, a combination thereof, or the like. For example, processor 106 may be able to determine that n number of clock cycles may occur between when a response is sent to be transmitted and when the response is transmitted. This may allow processor 106 to determine a transmit timestamp that may reflect when a NTP response may be sent before the NTP response is sent. Processor 106 may use the n number of clock cycles to calculate a time offset. Processor 106 may determine a transmit timestamp by adding the time offset to a timestamp retrieved from a clock. Processor 106 may include the transmit timestamp within the response to indicate when the NTP response may be sent.

Processor 106 may be connected to a clock that may tick at a rate that may be coordinated with throughput of the line connected to connector 102. For example, Gigabit Ethernet may be connected to connector 102 and may have a line throughput of 1 Gbps. Processor 106 may use a clock that may tick at a 1 GHz rate such that processor 106 may be able to process incoming packets a line rate throughput of 1 Gbps.

Processor 106 may be connected to a clock that may tick at a rate that may be faster than the speed of the line connected to connector 102. This may be done, for example, to allow processor 106 to operate at a rate that may be faster than the line rate throughput.

Processor 106 may be able to handle both packets in the NTP protocol and packets in the ARP protocol. The processor 106 may use the same hardware structure to handle both ARP and NTP packets. This may allow the pipeline to be used in a way such that packets may be processed at line rate throughput without packets being dropped and without overflowing a buffer.

NTP processing device 100 may include physical interface 104. Physical interface 104 may allow connector 102 to communicate with processor 106. Physical interface 104 may be connected to connector 102 and processor 106. Physical interface 104 may enable NTP processing device 100 to communicate with a network via a physical layer (PHY) of the network. The PHY may provide an electrical, a mechanical, or an optical interface that may be used to transmit data via the network.

Physical interface 104 may receive data packets from 106, may translate the data packets into a bit stream, and may transmit the bit stream over a physical link that may connect NTP Processing device 100 to a network. Physical interface 104 may receive a bit stream from a network via connector 102, may translate the bit stream into data packets, and may send the data packets to processor 106. A bit stream may be grouped into code words or symbols and may be converted into a physical signal that may be transmitted over a hardware transmission medium.

Physical interface 104 may be an Ethernet physical layer interface and may allow Processor 106 to use an Ethernet physical layer. The Ethernet physical layer may include a media-independent sublayer and a media-dependent sublayer.

The media-independent sublayer may include a reconciliation sublayer, a media-independent interface (MII), a gigabit media-independent interface (GMII), or the like. The media-independent sublayer may provide a logical connection between a media access control (MAC) layer and the media-dependent sublayers. The MII and GMII may provide separate transmit and receive data paths that may be bit-serial for 10-Mbps implementations, nibble-serial (4 bits wide) for 100-Mbps implementations, and byte-serial (8 bits wide) for 1000-Mbps implementations. The media-independent sublayer may be configured for full-duplex operation.

The media-dependent sublayer may include a physical coding sublayer (PCS), a physical medium attachment (PMA) sublayer, an auto-negotiation sublayer, a medium-dependent interface (MDI), or the like. The physical coding sublayer (PCS) may provide logic for encoding, multiplexing, and synchronization of outgoing bit streams. The PCS may provide symbol code alignment, demultiplexing, and decoding of bit streams. The physical medium attachment (PMA) sublayer may include signal transceivers and clock recovery logic for received bit streams. Medium-dependent interface (MDI) may be a cable connector between the signal transceivers and a network link. The auto-negotiation sublayer may allow NTP processing device 100 to send information about its capability. The auto-negotiation sublayer may allow NTP processing device 100 to negotiate and select an operational mode that it may be capable of supporting.

Physical interface 104 may support a number of network speeds. For example, physical interface 104 may support transmitting and/or receiving data at a 10 Mbps, 100 Mbps, 1 Gbps, 10 Gbps, or the like. Physical interface 104 may support transmitting and/or receiving data via a number of connectors. For example, physical interface 104 may allow processor 106 to receive data from a network using one connector and may allow processor 106 to transmit data using another connector.

NTP processing device 100 may include connector 102. Connector 102 may be connected to physical interface 104 and may communicate with processor 106. Connector 102 may be a physical port that may be used for a link layer of The Internet protocol suite. For example, Connector 102 may be an Ethernet port, a fast Ethernet port, a gigabit Ethernet port, a 10-gigabit Ethernet port, 100-gigabit Ethernet port, or the like. Connector 102 may be able connect to a network using a coaxial cable, a twisted pair cable, an optical fiber, or the like. Connector 102 may include a number of connectors that may be used to interface with a network. For example, connector 102 may include a first gigabit Ethernet port and a second gigabit Ethernet port. The first gigabit Ethernet port may be used to receive NTP requests from via the network. The second gigabit Ethernet port may be used to send NTP response via the network.

FIG. 1B illustrates an example of a computing environment that may be used to implement cycle accurate time stamping at line rate throughput. Computing system environment 120 is not intended to suggest any limitation as to the scope of use or functionality of the disclosed subject matter. Computing environment 120 should not be interpreted as having any dependency or requirement relating to the components illustrated in FIG. 1B. For example, in some cases, a software process may be transformed into an equivalent hardware structure, and a hardware structure may be transformed into an equivalent software process. The selection of a hardware implementation versus a software implementation may be one of design choice and may be left to the implementer.

The computing elements shown in FIG. 1B may include circuitry that may be configured to implement aspects of the disclosure. Circuitry may include hardware components that may be configured to perform function(s) by firmware or switches. Circuitry may include a processor, a memory, or the like that may be configured by software instructions. Circuitry may include a combination of hardware and software. For example, source code that may embody logic may be compiled into machine-readable code and may be processed by a processor.

As shown in FIG. 1B, computing environment 120 may include computer 141 and may include a variety of computer readable media that may be accessed by computer 141. The computer readable media may include volatile media, nonvolatile media, removable media, non-removable media, or the like. System memory 122 may include read only memory (ROM) 123 and random access memory (RAM) 160. ROM 123 may include basic input/output system (BIOS) 124. BIOS 124 may include basic routines that may help to transfer data between elements within computer 141 during start-up. RAM 160 may include data and/or program modules that may be accessible to by processing unit 159. ROM 123 may include operating system 125, application program 126, program module 127, and program data 128.

Computer 141 may also include other computer storage media. For example, computer 141 may include hard drive 138, media drive 140, USB flash drive 154, or the like. Media drive 140 may be a DVD/CD drive, hard drive, a disk drive, a removable media drive, flash memory cards, digital versatile disks, digital video tape, solid state RAM, solid state ROM, or the like. The media drive 140 may be internal or external to computer 141. Computer 141 may access data on media drive 140 for execution, playback, or the like. Hard drive 138 may be connected to system bus 121 by a memory interface such as memory interface 134. Universal serial bus (USB) flash drive 154 and media drive 140 may be connected to the system bus 121 by memory interface 135.

As shown in FIG. 1B, the drives and their computer storage media may provide storage of computer readable instructions, data structures, program modules, and other data for computer 141. For example, hard drive 138 may store operating system 158, application program 157, program module 156, and program data 155. These components may be or may be related to operating system 125, application program 126, program module 127, and program data 128. For example, program module 127 may be created by computer 141 when computer 141 may load program module 156 into RAM 160.

A user may enter commands and information into the computer 141 through input devices such as keyboard 151 and pointing device 152. Pointing device 152 may be a mouse, a trackball, a touch pad, or the like. Other input devices (not shown) may include a microphone, joystick, game pad, scanner, or the like. Input devices may be connected to user input interface 136 that may be coupled to system bus 121. This may be done, for example, to allow the input devices to communicate with processing unit 159. User input interface 136 may include a number of interfaces or bus structures such as a parallel port, a game port, a serial port, a USB port, or the like.

Computer 141 may include graphics processing unit (GPU) 129. GPU 129 may be connected to system bus 121. GPU 129 may provide a video processing pipeline for high speed and high-resolution graphics processing. Data may be carried from GPU 129 to video interface 132 via system bus 121. For example, GPU 129 may output data to an audio/video port (A/V) port that may be controlled by video interface 132 for transmission to display device 142.

Display device 142 may be connected to system bus 121 via an interface such as a video interface 132. Display device 142 may be a liquid crystal display (LCD), an organic light-emitting diode (OLED) display, a touchscreen, or the like. For example, display device 142 may be a touchscreen that may display information to a user and may receive input from a user for computer 141. Computer 141 may be connected to peripheral 143. Peripheral interface 133 may allow computer 141 to send data to and receive data from peripheral 143. Peripheral 143 may include an accelerometer, an e-compass, a satellite transceiver, a digital camera (for photographs or video), a USB port, a vibration device, a television transceiver, a hands free headset, a Bluetooth® module, a frequency modulated (FM) radio unit, a digital music player, a media player, a video game player module, a speaker, a printer, or the like.

Computer 141 may operate in a networked environment and may communicate with a remote computer such as computer 146. Computer 146 may be a computer, a server, a router, a tablet, a smart phone, a peer device or other network node. Computer 141 may communicate with computer 146 using network 149. For example, computer 141 may use network interface 137 to communicate with computer 146 via network 149. Network 149 may represent the communication pathways between computer 141 and computer 146. Network 149 may be a local area network (LAN), a wide area network (WAN), a wireless network, a cellular network, or the like. Network 149 may use Internet communications technologies and/or protocols. For example, network 149 may include links using technologies such as Ethernet, IEEE 802.11, IEEE 806.16, WiMAX, 3GPP LTE, integrated services digital network (ISDN), asynchronous transfer mode (ATM), or the like. The networking protocols that may be used on network 149 may include the transmission control protocol/Internet protocol (TCP/IP), the hypertext transport protocol (HTTP), the simple mail transfer protocol (SMTP), the file transfer protocol (FTP), or the like. Data exchanged may be exchanged via network 149 using technologies and/or formats such as the hypertext markup language (HTML), the extensible markup language (XML), or the like. Network 149 may have links that may be encrypted using encryption technologies such as the secure sockets layer (SSL), Secure HTTP (HTTPS) and/or virtual private networks (VPNs).

Computer 141 may include NTP processing device 100. NTP processing device may be connected to system bus 121 and may be connected to network 149. NTP processing device 100 may have more than one connection to network 149. For example, NTP processing device 100 may have a Gigabit Ethernet connection to receive data from the network and a Gigabit Ethernet connection to send data to the network. This may be done, for example, to allow NTP processing device 100 to timestamp data packets at line rate throughput.

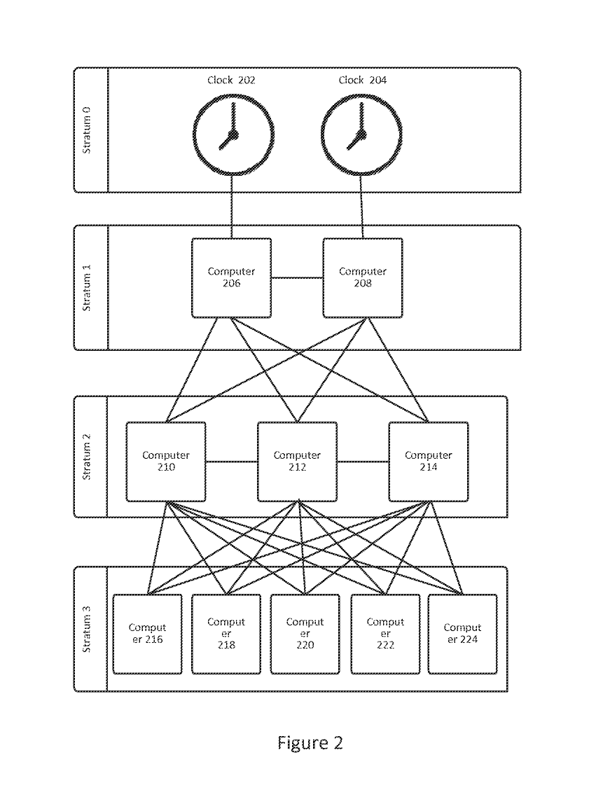

FIG. 2 illustrates an example of a hierarchy that may be used for NTP. NTP may be designed to discipline one or more clocks within a network. NTP may run over UDP. Timekeeping may be synchronized among a set of servers and/or clients. A set of nodes in a network may be identified and may be configured with NTP. The nodes may be machines such as computers.

A NTP network may get its time from a reference time source such as a radio clock or an atomic clock that may be attached to a timeserver. NTP may distribute this time across a network by disciplining clocks across devices. A packet may be used between two devices to discipline a clock. The packet may be sent in response to an NTP request. For example, an NTP client may send a request to an NTP server and may receive a packet. The packet may be used by the NTP client to discipline the clock of the NTP client against a reference clock, which may be the clock of the NTP server.

NTP may use the concept of a stratum to describe how many NTP hops away a machine may be from an reference time source such as an atomic clock. NTP may use a hierarchy system of clock sources. Each level of this hierarchy may be termed a stratum and each stratum may be assigned a layer number starting with zero at the top. The stratus level may define its distance from a reference clock and may prevent cyclical dependences in the hierarchy.

As shown in FIG. 2, a NTP hierarchy may include three stratum such as Stratum 0, Stratum 1, Stratum 2, and Stratum 3. Stratum 0 may include clock 202 and clock 204. Clock 202 and/or clock 204 may be a reference clock such as an atomic clock, a GPS clock, a radio clock, or the like. Clock 202 and/or clock 204 may not be attached to the network. Clock 202 and/or clock 204 may be connected to a computer. For example, clock 202 may be connected to computer 206. As another example, clock 204 may be connected to computer 208.

Stratum 1 may be computers that may be attached to Stratum 0 devices. Stratum 1 may include computer 206 and computer 208. Computer 206 may be connected to clock 202. Computer 208 may be connected to clock 204. Computer 206 and computer 208 may be able to communicate with each other. Computer 206 and/or computer 208 may be able to act as a server for timing requests that may be sent from Stratum 2 computers. For example, computer 206 may receive and respond to timing requests from computer 210, computer 212, and/or computer 214.

Stratum 2 computers may be computers that may send NTP requests to Stratum 1 computers. Computer 210, computer 212, and computer 214 may be Stratum 2 computers. A computer running NTP may choose the device with the lowest stratum number that it may be configured to communicate with using NTP as its time source. For example, computer 210 may select computer 206 as a time source. A Stratum 2 computer may reference a number of Stratum 1 computers and may select one or more Stratum 1 computers that may provide stable data. For example, computer 210 may reference computer 206 and computer 208. Computer 210 may send timing requests to computer 206 and computer 208. Computer 210 may receive a timing response from computer 206 and may receive a timing response from computer 208. A Stratum 2 computer may be prevented from disciplining a clock using a device whose time may not be accurate. For example, computer 210 may determine that a timing response received from computer 208 may be better than the timing response received from computer 206. Computer 210 may determine that the timing response received from computer 206 may not be accurate. Computer 210 may decide to use the timing response received from Computer 208 and may avoid sending further requests to computer 206.

Stratum 2 computers may communicate with each other. Stratum 2 computers may peer with each other to provide timing for devices in the peer group. For example, computer 210, computer 212, and computer 214 may send and receive timing requests from each other to discipline clocks among computer 210, computer 212, and computer 214. Stratum 2 computers may respond to timing requests from computers that may be in stratum 3 such as computer 216.

Stratum 3 computers may send timing request such as NTP request, to Stratum 2 computers. Computer 216, computer 218, computer 220, computer 222, and computer 223 may be stratum 3 computers. A computer running NTP may choose the machine with lowest stratum number that it may be configured to communicate using NTP as a time source. For example, computer 216 may select computer 210 as a time source. A Stratum 3 computer may reference a number of Stratum 2 computers and may select one or more Stratum 2 servers that may provide data. For example, computer 216 may reference computer 210 and/or computer 212. Computer 216 may send timing request to computer 210 and/or computer 212. Computer 216 may receive a timing response from computer 210 and may receive a timing response from computer 212. A Stratum 3 computer may be prevented from disciplining a clock to a device whose time may not be accurate. For example, computer 216 may determine that a timing response received from computer 210 may be better than a timing response received from computer 212. Computer 216 may decide to use the timing response received from computer 210 and may avoid sending further requests to computer 210.

Stratum 3 computers may communicate with each other. Stratum 3 computer may peer with each other to provide timing for devices in the peer group. For example, computer 216, computer 218, computer 220, computer 222, and computer 224 may send and receive timing requests from each other to time discipline a clock. Stratum 3 computers may respond to timing request from computer in a lower stratum such as Stratum 4 computer.

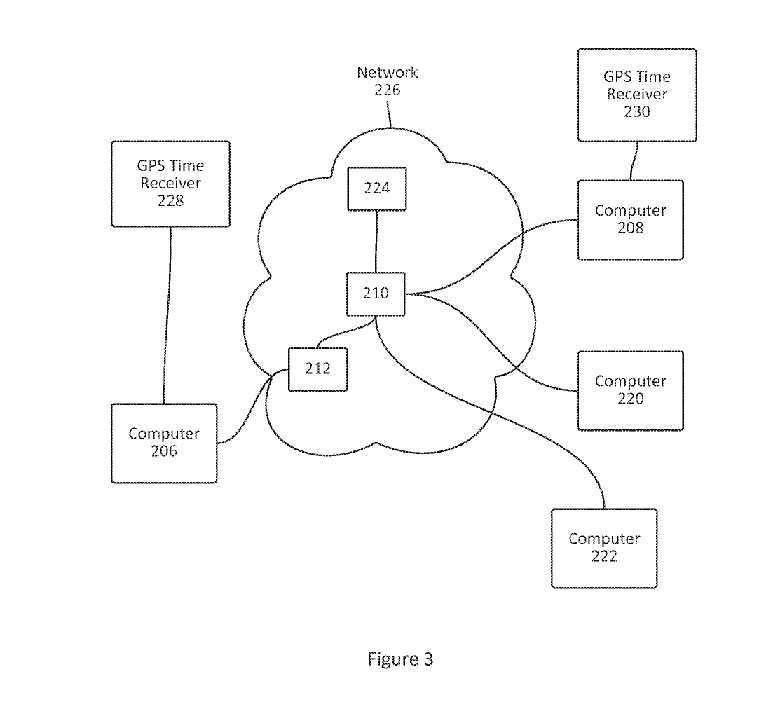

FIG. 3 illustrates an example of a network system that may use a protocol to discipline a clock such as NTP. As shown in FIG. 3, a server such as computer 206, may be connected to a global positioning satellite (GPS) time receiver 228 and may be connected to network 226. Computer 206 may be a Stratum 1 server.

Network 226 may be a packet-switched network such as an IP packet-switched network. Network 226 may include a number of network nodes such as computer 224, computer 210, and computer 212. Computer 224 may be a Stratum 3 server. Computer 210 and computer 212 may be Stratum 2 servers. A number of computers may connect to network 226 such as computer 206, computer 208, computer 220, and computer 222. Computer 206 and computer 208 may be Stratum 1 servers. Computer 220 and computer 222 may be Stratum 3 servers.

Network 226 may forward a packet based on a destination address within the packet. The designation address may be an IP address, an Ethernet address, a MAC address, or the like. A network node in network 226 may be used to relay a packet from one destination to another. For example, a packet may be sent from computer 206 to computer 222 via computer 212 and computer 210. As another example, a packet may be sent from computer 220 to computer 208 via computer 210.

GPS time receiver 228 may calculate a time based on signal received from a GPS satellite. GPS time receiver 228 may be classified as Stratum 0. Computer 206 may receive a time from GPS time receiver 228 and may use the time to discipline a clock that may belong to computer 206. Computer 206 may use time from GPS time receiver 228 to respond to a timing request. The timing request may be a request to align a clock that may belong to another computer such as a computer at the same or lower stratum.

For example, computer 206 may receive a timing request that may be sent by computer 222. The timing request may indicate that computer 222 may wish to discipline its clock. Computer 206 may generate a timing response that may include a reference timestamp, an originate time stamp, a transmit timestamp, and/or a receive timestamp. The timing response may be sent to computer 222 to discipline the clock in computer 222 with the clock in computer 206.

Computer 208 may be connected to network 226 and may be connected to GPS time receiver 230. GPS time receiver 230 may be classified as Stratum 0. GPS time receiver 230 may calculate a time from a GPS satellite. The calculated time may be used to synchronize a clock that may belong to computer 208, which may be a Stratum 1 server. Computer 208 may respond to a timing request that may be sent by computer 220, computer 222, or computer 206.

For example, computer 208 may receive a timing request that may be sent by computer 206. Computer 208 and computer 206 may be peers such as Stratum 1 peers. The timing request may indicate that computer 206 may wish to discipline its clock with a clock that may belong to computer 208. Computer 208 may generate a timing response that may include a reference timestamp, an originate timestamp, and/or a transmit timestamp. The timing response may be sent to computer 206 to allow computer 206 to discipline its clock with the clock in computer 208.

Computer 208 and/or computer 206 may be used to measure network performance. Network congestion may be caused when a link or a node in network 226 may be carrying so much data that quality of service may deteriorate. For example, network congestion may affect packet delivery times and may cause clock synchronization issues. Computer 208 and computer 206 may discipline their clocks without using network 226. For example, computer 208 and computer 206 may discipline their clocks using GPS signals that may not be affected by congestion occurring within network 226. This may allow computer 208 and computer 206 to avoid clock synchronization issues caused by the network congestion and may allow computer 208 and computer 206 to be used to measure how the congestion may affect packet delivery times.

For example, computer 208 may be used to measure an amount of delay that may occur when a packet is transmitted using network 226. Computer 206 and computer 208 may discipline their clocks time according to a GPS signal such that the clock in computer 208 may not be affected by network congestion within network 226. Computer 208 may then receive a data packet from computer 206 via network 226. The data packet may include a transmit timestamp that may indicate when computer 206 transmitted the data packet. Because the clocks of computer 208 and computer 206 may have been disciplined without using network 226, computer 208 may assume that the received timestamp may be accurate (e.g. the receive timestamp may not include errors caused by congestion within network 226). When computer 208 receives the data packet, computer 208 may stamp the data packet with a receive timestamp. Using the receive timestamp and the transmit timestamp, computer 208 may calculate a network transmit delay. The network transmit delay may indicate the time it takes a packet to be sent via network 226. If the network transmit delay is above a threshold, then the network transmit delay may indicate that network congestion may be occurring.

Computer 220 and computer 222 may act as peers and may synchronize time with each other. Computer 220 and computer 222 may be stratum 3 servers and may send and receive timing requests from each other to synchronize time. Computer 220 and/or computer 222 may respond to timing requests from computers that may be in a lower stratum.

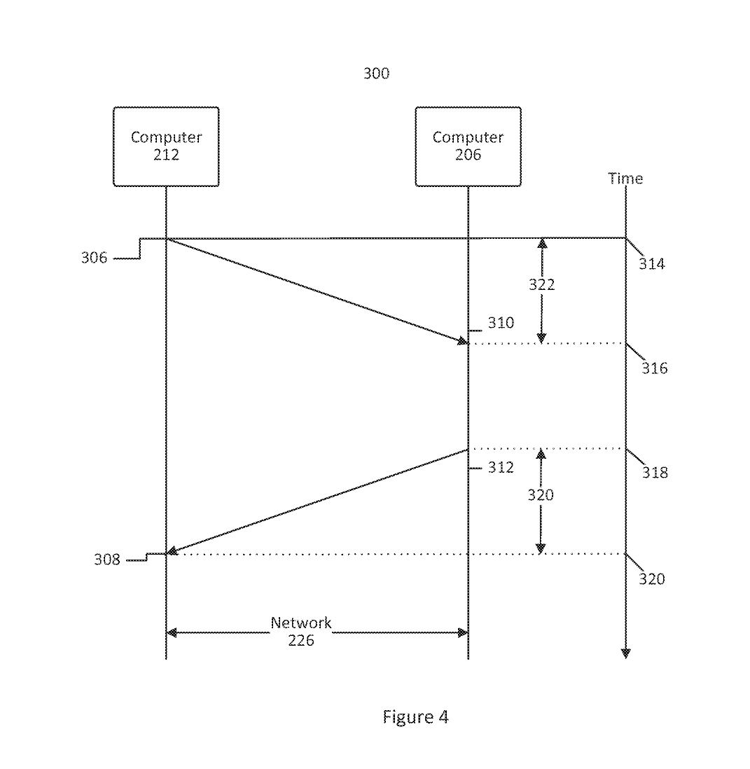

FIG. 4 illustrates an example of an NTP interaction that may allow a clock to be disciplined. For example, FIG. 4 may illustrate how computer 212 may discipline its clock against a clock associated with computer 206.

At 306, computer 212 may send a timing request to computer 206. Computer 206 may be a Stratum 1 server and may have a clock. Computer 212 may be a Stratum 2 server, may have a clock that may need to be disciplined. The timing request may include a timestamp t₀, which may be a timestamp from computer 212 that may indicate when computer 212 sent the timing request. Computer 212 may determine that the timing request may be sent at time 314, may set timestamp t₀ to time 314, may include timestamp t₀ in the timing request, and may send the timing request to computer 212.

At 310, computer 206 may receive the timing request sent by computer 206. Computer 206 may stamp the timing request with a timestamp t₁ to indicate when computer 206 may have received the timing request from the computer 212. For example, computer 206 may set the timestamp t₁ to time 316.

At 312, computer 206 may send a timing response. The timing response may include the timestamp t₁ and may include the timestamp t₀. Computer 206 may stamp the timing response with a timestamp t₂ that may indicate when computer 206 may send the timing response. For example, computer 206 may set timestamp t₂ to time 318, may include timestamp t₂ in the timing response, and may send the timing response to computer 212.

At 308, computer 212 may receive the timing response. The timing response may include timestamp t₀, timestamp t₁, and/or timestamp t₂. When computer 212 receives the timing response, computer 212 may timestamp the timing response with a timestamp t₃. Timestamp t₃ may be a timestamp from computer 212 that may indicate when computer 212 received the timing response. For example, timestamp t₃ may indicate that computer 212 received the timing response at 320.

Computer 212 may use the timing response to discipline its clock. For example, to discipline its clock, computer 212 round-trip delay time, δ, and an offset, θ, as described herein. Computer 212 may calculate the time that may have passed between the sending of the request at 306 and the receipt of the response at 308 (e.g. t₃−t₀). The time that passed between the sending of the timing request and the receiving the timing response may be the difference between time 320 and time 314. Computer 212 may calculate the time it may have taken computer 206 to process the request and send a response (e.g. t₂−t₃). The time it may have taken computer 206 to process the timing request and send the timing response may be the difference between time 318 and time 316.

At 322, computer 212 may calculate how much network 226 may have delayed computer 206 from receiving the timing request sent by computer 212. For example, the delay may be the difference between time 316 and time 314. The delay calculated at 322 may be used to indicate performance in network 226 such as level of congestion or load. At 320, computer 212 may calculate how much network 226 may have delayed computer 212 from receiving the timing response sent by computer 206. For example, the delay may be the difference between time 320 and time 318. The delay calculated at 320 may be used to indicate performance in network 226 such as level of congestion or load.

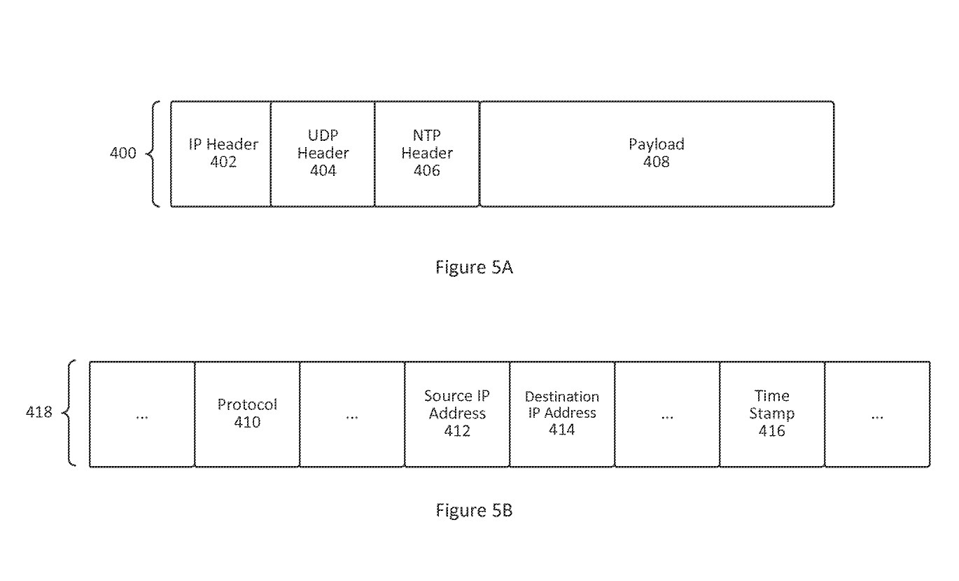

FIG. 5A illustrates an example of an Ethernet data packet structure that may include an NTP packet. As shown in FIG. 5, Ethernet data packet 400 may include an IP header such as IP header 402, a UDP header such as UDP header 404, a NTP header such as NTP header 406, a payload such as payload 408, a combination thereof, or the like. Payload 408 may include IP payload data, UDP payload data, NTP payload data, a combination thereof, or the like. Ethernet data packet 400 may be used by one computer to communicate with another computer via a network such as the Internet. Ethernet data packet 400 may be used by a computer to discipline a clock of the computer with a clock that may belong to a server. For example, Ethernet data packet 400 may include NTP protocol data that may be used by a computer to discipline its clock.

Ethernet packet may include IP header 402 that may be a header for an IP packet. IP header 402 may be used to allow a computer to communicate via an IP protocol. IP header 402 may be an IPv4 header, an IPv6 header, or the like. IP header 402 may include information about an IP data payload that may be within payload 408. IP header 402 may include a number of fields. For example, IP header 402 may include a version field, a header length field, a service type field, a total length field, an identification field, a flag field, a fragment offset field, a time to live (TTL) field, a protocol field, a header checksum field, a source IP address field, a destination IP address field, an options field, a combination thereof, or the like. IP header 402 may include a number of bits that may be used for padding.

Ethernet data packet 400 may include UDP header 404. UDP header 404 may be a UDP header and may be used for the UDP protocol. The UDP header may be used, for example, by a computer application to send messages such as datagrams, to other computers to set up communication channels and/or data paths. UDP header 404 may include information about a UDP payload. UDP header 404 may include a number of fields such as a source port field, a destination port field, a length field, and a checksum field. UDP header 404 may follow IP header 402. UDP header 404 may be encapsulated within an IP payload, which may use IP header 402 as an IP header. For example, UDP header 404 and a UDP payload may be encapsulated within an IP payload that may use IP header 402.

NTP header 406 may be a NTP protocol header. NTP header 406 may be used, for example, by a computer to discipline its clock against a reference clock. NTP header 406 may include information about a NTP payload. NTP header 406 may have a bit length such as a 32 bit length, a 64 bit length, or the like. NTP header 406 may include a cryptosum, and may include an authenticator. NTP header 406 may include a leap warning indicator field, a version number field, a stratum field, a poll interval field, a precision field, or the like. NTP header 406 may include a root delay field, a root dispersion field, a reference identifier field, a reference timestamp, an originate timestamp, a receive timestamp, a transmit time stamp, or the like. NTP header 406 may include a key identifier, an algorithm identifier, a message hash, or the like.

NTP header 406 may follow UDP header 404. NTP header 406 may be encapsulated within a UDP payload, which may use UDP header 404 as a UDP header. For example, NTP header 406 and a NTP payload may be encapsulated within a UDP payload that may use UDP header 404.

FIG. 5B illustrates an example of a data packet that may allow a clock to be disciplined. For example, computer 212 may use packet 418 to discipline its clock with a clock that may belong to a server such as computer 206. Packet 418 may be an Ethernet packet.

As shown in FIG. 5B, packet 418 may include protocol 410, source IP address 412, destination IP address 414, and timestamp 416. Protocol 410 may be used by a recipient device to determine a protocol that may be used to process packet 418. This may be done, for example, to allow a recipient device to identify other fields within packet 418 such as source IP address 412, destination IP address 414, timestamp 416, or the like. Source IP address 412 may identify an IP address for a device that may have sent packet 418. Destination IP address 414 may identify an IP address to which packet 418 may be delivered via a network. Timestamp 330 may be a reference timestamp, an originate time stamp, a transmit timestamp, a receive timestamp, a combination thereof or the like. For example timestamp 416 may be a transmit timestamp that may indicate when packet 418 may have been transmitted.

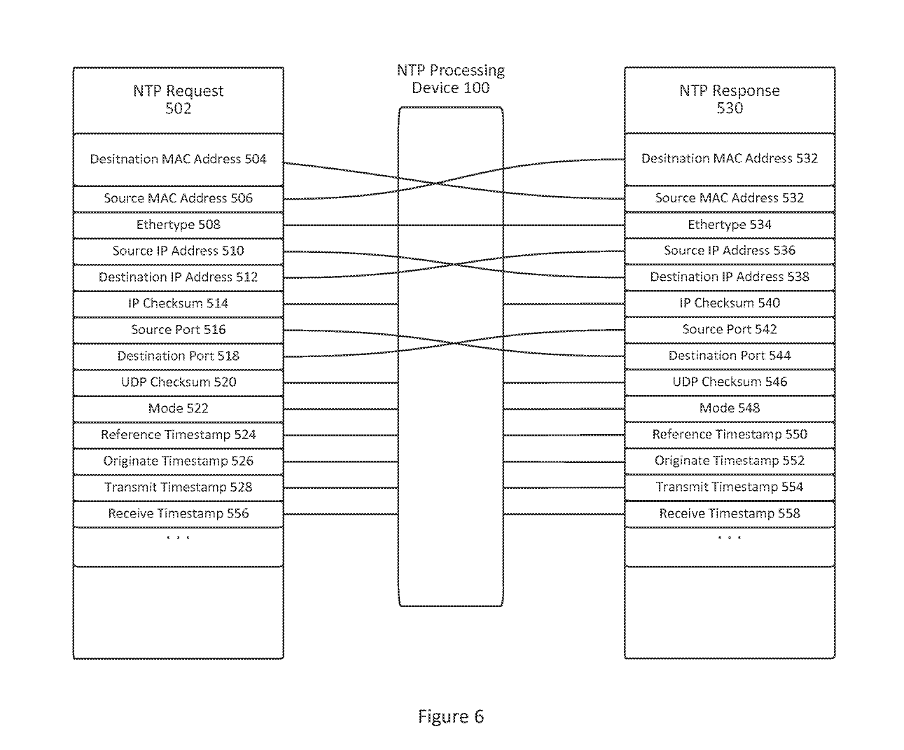

FIG. 6 illustrates an example method for responding to an address resolution request (e.g. an ARP request, a NDP request, etc.) and/or a timing request (e.g. an NTP request, a PTP request, etc.). As shown in FIG. 6, NTP processing device 100 may receive an NTP request such as NTP request 502. NTP request 502 may have a geometry that may be similar to that of NTP response 530. This may be done, for example, so that NTP processing device may be able to receive and/or respond to NTP requests at line rate throughput. For example, NTP processing device 100 may respond to a NTP request or an ARP request without dropping packets or overflowing a buffer. As another example, NTP processing device 100 may respond to a NTP request or an ARP request without fully implementation a MAC layer. NTP request 502 may include destination MAC address 504, which may indicate a MAC address of a device that may be able to process NTP request 502.

As described herein, NTP processing device 100 may process NTP request 502 and may generate a NTP response such as NTP response 530. In generating NTP response 530, NTP processing device 100 may create a number of fields, populate those fields with data, and include those fields in NTP response 530. This may be done, for example, to enable a device that sent NTP request 502 to be able to discipline its clock.

NTP processing device 100 may generate NTP response 530 and may send NTP response 530 to the device that sent NTP request 502. The device that sent NTP request 520 may be identified by source MAC address 506. To ensure that NTP response 530 is transmitted to the device that sent NTP request 530, NTP processing device may set destination MAC address 532 to source MAC address 506. Destination MAC address 532 may indicate the MAC address of the device that may receive NTP response 530.

NTP processing device 100 may include its MAC address in NTP response 530, such that it may be identified as the source of NTP response 530. For example, NTP processing device 100 may set source MAC address 532 as the MAC address of NTP processing device 100. As another example, NTP processing device 100 may set source MAC address 532 to the MAC address stored in destination MAC address 504. Destination MAC address 504 may indicate the MAC address of the device that may have received NTP request 502. Destination MAC address 504 may be the MAC address for NTP processing device 100.

Ethertype 534 may be included in NTP response 530 to indicate a protocol that may be used to interpret NTP response 530. For example, Ethertype 534 may indicate that a protocol such as IPv4, IPv6, wake-on-LAN, AppleTalk, IPX, precision time protocol (PTP), or the like, may be used. NTP processing device may set Ethertype 534 to the Etherype that may be indicated by Ethertype 508.

NTP response 530 may include destination IP address 538. Destination IP address 538 may indicate the IP address of the device that may receive NTP response 530, which may also be the device that may have sent NTP request 502. Destination IP address 538 may be the IP address of the device that may have sent NTP request 502. NTP processing device 100 may set the destination IP address 538 to source IP address 510, to ensure that NTP response 530 may be sent to the IP address that sent NTP request 502.

NTP processing device 100 may include the IP address that may have be used to send NTP response 530, which may be the IP address for NTP processing device 100. This may be done, for example, to allow the device receives NTP response 530 to identify the IP address of NTP processing device 100. As destination IP address may be the IP address of NTP processing device 100, NTP processing device 100 may set source IP address 536 to destination IP address 512.

IP checksum 514 may be a block of data that may be used to detect errors that may have been introduced to an IP header that may include source IP address 510 and destination IP address 512. NTP processing device 100 may receive NTP request 502 and may use IP checksum 514 to verify source IP address 510 and/or destination IP address 512. For example, NTP processing device 100 may retrieve IP checksum 514 from NTP request 502. NTP processing device 100 may use IP checksum 514 to detect an error within source IP address 510 and/or destination IP address 512. If NTP processing device 100 may detect an error within source IP address 510 and/or destination IP address 512, NTP processing device 100 may delete NTP request and may not generate a NTP response. If NTP processing device 100 detects that source IP address 510 and/or destination IP address 512 may be error-free, NTP processing device 100 may generate a NTP response such as NTP response 530.

NTP processing device may include IP checksum 540 in NTP response 530. IP checksum 540 may be a block of data that may be used to detect errors that may have been introduced to an IP address such as source IP address 536 and destination IP address 538. This may allow a device that may receive NTP response 530 to detect errors that may have been introduced to an IP address such as source IP address 510 and destination IP address 512. NTP processing device may generate an IP checksum based on source IP address 536 and/or destination IP address 538. NTP processing device 100 may be able to generate the IP checksum in such a way that NTP processing device 100 may continue to process NTP requests at line rate throughput. NTP processing device may set IP checksum 540 to the generated checksum. IP checksum 540 may then be used by a device receiving NTP response 530 to verify that source IP address 536 and/or destination IP address 538 are correct.

NTP response 530 may include source port 542, which may be a UDP port address. Source port 542 may be a port address that may be used to send the NTP response 530. For example, NTP processing device 100 may a use the UDP port indicated by source port 542 to send NTP response 530. Source port 542 may be the port address that may have been used to receive NTP request 502. For example, NTP processing device 100 may receive NTP request 502 via destination port 518. NTP processing device 100 may generate NTP response 530 and may use the UDP port indicated by destination port 518 to send the NTP response 530. NTP processing device may include the UDP port address that may be used to send NTP response 530 within NTP response 530. This may be done, for example, by setting source port 542 to the UDP port indicated by destination port 518. In some cases, NTP processing device 100 may use a port that may be different from port indicated by destination port 518. In those cases, NTP processing device 100 may determine what port may be used to send NTP response 530, may set source port 542 to that port, and may send NTP response 530 using that port.

NTP Response 530 may include destination port 544, which may be a UDP port address. Destination port 544 may be the port address that may receive NTP response 530. For example, a device receiving NTP response 530 may receive NTP response 530 via the port indicated by destination port 544. Destination port 544 may be set to the port address that may have been used to send NTP request 502. For example, NTP processing device 100 may receive NTP request 502, which may have been sent via the port indicated by source port 516. To send a NTP response back to the device that sent the NTP request, NTP processing device 100 may send the NTP response to the same port from which the NTP request was received. For example, NTP processing device may generate NTP response 530, may set destination port 544 to the port indicated by source port 516, and may send NTP response 530 to the port indicated by destination port 544. In some cases, NTP processing device may send a NTP response to an address that may be different from the port address that transmitted the NTP request. In those cases, destination port 544 may be set to a port address that may be different from the port address indicated by source port 516.

UDP checksum 520 may be a block of data that may be used to detect errors that may have been introduced to a UDP port address such as source port 516 and destination port 518. NTP processing device 100 may receive NTP request 502 and may use UDP checksum 520 to verify that source port 516 and/or destination port 518 include correct port addresses. For example, NTP processing device 100 may retrieve UDP checksum 520 from NTP request 502. NTP processing device 100 may use checksum 520 to detect an error within source port 516 and/or destination port 518. If NTP processing device 100 may detect an error within source port 516 and/or destination port 518, NTP processing device 100 may delete NTP request 502 and may not generate a NTP response. If NTP processing device 100 detects that source port 516 and/or destination port 518 may be free of errors, NTP processing device 100 may generate a NTP response such as NTP response 530.

NTP processing device may include UDP checksum 546 in NTP response 530. UDP checksum 546 may be a block of data that may be used for detecting errors that may have been introduced to a UDP port address such as source port 542 and destination port 544. A device that may receive NTP response 530 may use UDP checksum 546 to verify that source port 542 and/or destination port 544 include correct port address(s). For example, NTP processing device 100 may include source port 542 and destination port 544 in NTP response 530. NTP processing device 100 may calculate UDP checksum 546 using source port 542 and/or destination port 544. NTP processing device 100 may include UDP checksum 546 in NTP response 530 and may transmit NTP response 530 to a device, which may use UDP checksum 546 to verify source port 542 and/or destination port 544.

NTP processing device 100 may be capable of operating in an operating mode such as an association mode, a client/server mode, a symmetric active/passive mode, a broadcast mode, an IP multicast support mode, a multicasting mode, a manycasting mode, a burst mode, or the like. NTP processing device 100 may be able to operating in an operating mode indicated by mode 522 and/or mode 548. For example, NTP processing device 100 may receive NTP request 502, may retrieve mode 522, may determine an operating mode indicated by mode 522, and may operate in that operating mode. As another example, NTP processing device 100 may operate in an operating mode, may generate NTP response 530 while in that operating mode, and may indicate the operating mode used while generating NTP response 530 by setting mode 548 to that operating mode.

NTP processing device 100 may receive a NTP request such as NTP request 502. The NTP response may be a request for NTP processing device 100 to provide a NTP response that may be used to discipline a clock. For example, a device may have a clock that may be out of synchronization. To discipline its clock, the device may send a NTP response to NTP processing device. NTP processing device 100 may response to the requesting device an NTP response. The requesting device may use the NTP response to discipline its clock.

The NTP request may include a reference timestamp, a originate timestamp, and a transmit time stamp. For example, NTP processing device 100 may receive NTP request 502. NTP request 502 may include reference timestamp 524, originate timestamp 526, and transmit timestamp 528. Reference timestamp 524 may be set to zero or may be the time a requesting clock, which may be the clock of the requesting device, was last set or corrected. Originate timestamp 526 may be set to zero or may be the time when the NTP request was sent by the requesting device to NTP processing device 100. Transmit timestamp 528 may be zero or may indicate the when a requesting device transmitted a data packet such as NTP request 502, NTP response 530, or the like.

NTP processing device 100 may generate a NTP response such as NTP response 530, that may be used to discipline a clock. For example, NTP response 530 may be used to discipline clock that may belong to the device that sent NTP request 502. NTP response 530 may include a reference timestamp, a originate timestamp, a transmit timestamp, a receive timestamp, a combination thereof, or the like. For example, NTP processing device 100 may generate NTP response 530. NTP response 530 may include reference timestamp 550, originate timestamp 552, transmit timestamp 554, receive timestamp 558, a combination thereof, or the like. Reference timestamp 550 may be a timestamp from a reference clock. Originate timestamp 552 may indicate when a NTP request was sent by a requesting device to NTP processing device 100. Transmit timestamp 528 may indicate when NTP processing device 100 may transmit NTP response 530. Receive timestamp 558 may indicate when NTP processing device 100 may have received a NTP request such as NTP request 502.

NTP processing device 100 may generate NTP response 530 using NTP request 502. For example, a requesting device may send NTP request 502 to NTP processing device 100 at time t₀. Reference timestamp 524 and originate timestamp 526 may not have a value. Transmit timestamp 528 may be set to t₀ to indicate when the request may have been sent. NTP processing device 100 may receive NTP request 502 at time t₁ and NTP processing device 100 may set a receive timestamp to time t₁, which may indicate when NTP processing device 100 received NTP request 502. The receive timestamp may be included in NTP response 530. For example, NTP processing device may set receive timestamp 558 to time t₁. NTP processing device 100 and may set originate timestamp 552 to t₀, which may indicate when NTP request 502 was sent to NTP processing device 100. NTP processing device 100 may determine that NTP response 530 may be sent at time t₂ and may set transmit timestamp 554 to t₂. NTP processing device 100 may determine a time using a reference clock and may set reference timestamp 550 to that time. NTP processing device may send NTP response 530 to the requesting device at time t₂. At time t₃, the requesting device may receive NTP response 530, and may stamp NTP response 530 with a receive timestamp.

As another example, a requesting device may send NTP request 502 to NTP processing device 100 at time t₄. Receive timestamp 556 may be set to time t₃, which may indicate when a NTP response may have been received. Reference timestamp 524 may be set to time t₂, which may indicate when the clock of the requesting device may have been disciplined. Originate timestamp 526 may be set to time t₃, which may be the time when a previous NTP response was sent by NTP processing device 100. Transmit timestamp 528 may be set to t₄ to indicate when NTP request 502 may be sent to NTP processing device 100. NTP processing device 100 may receive NTP request 502 at time t₅ and NTP processing device 100 may set a receive timestamp such as receive timestamp 558, to time t₅. NTP processing device 100 may set originate timestamp 552 to time t₄, which may indicate when NTP request 502 was sent to NTP processing device 100. NTP processing device 100 may determine that NTP response 530 may be sent at time t₆ and may set transmit timestamp 554 to time t₆. NTP processing device 100 may determine a time using a reference clock and may set reference timestamp 550 to that time. NTP processing device may send NTP response 530 to the requesting device at time t₆. At time t₇, the requesting device may receive NTP response 530 and may stamp NTP response 530 with a receive timestamp.

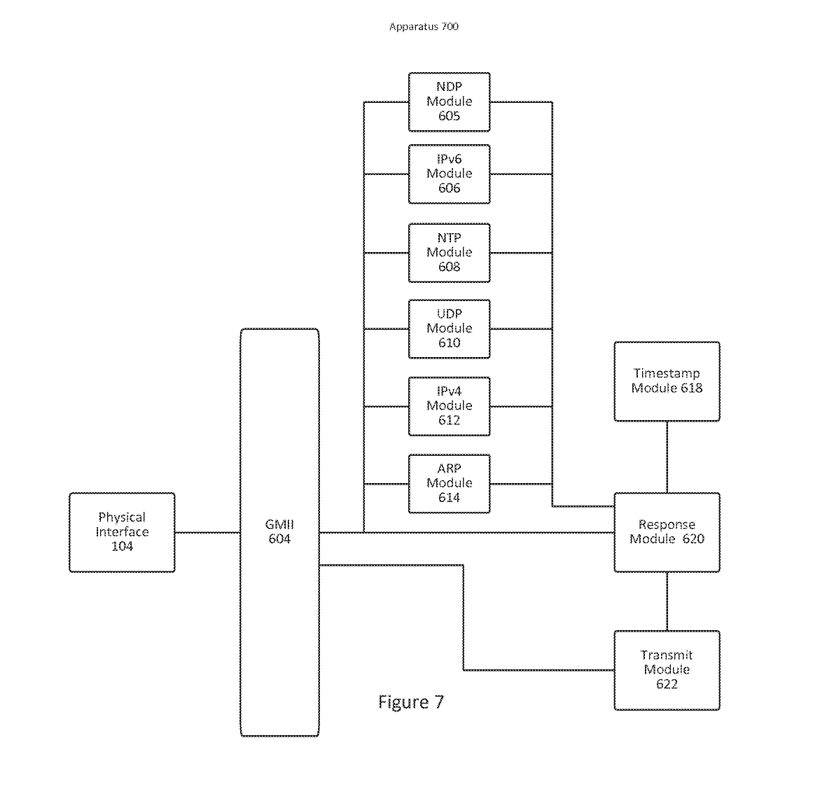

FIG. 7 illustrates an example apparatus for responding to a timing request (e.g. a NTP request, a PTP request, etc.) and/or an address resolution request (e.g. an ARP request, a NDP request, etc.). For example, apparatus 700 may be a NTP processing device such as NTP processing device 100. Apparatus 700 may be used to provide a hardware based NTP server and may be able to generate timing responses and/or address resolution response at a line rate throughput. For example, apparatus 700 may be able to receive timing requests at line rate throughput via a first Gigabit Ethernet, generate timing responses at the line rate throughput, and transmit the timing responses at a line rate throughput via a Gigabit Ethernet. Apparatus 700 may be able to handle timing requests and address resolution responses using the same data path. For example, apparatus 700 may be able to handle ARP request and NTP requests using the same data path and may be able to handle those requests at line rate throughput. As another example, apparatus 700 may be able to handle NDP requests and NTP requests using the same data path and may be able to handle those requests at a line rate throughput. Apparatus 700 may include a data pipeline that may be used for responding to a timing request and may be used for responding to an address resolution request. For example, apparatus 700 may include a data pipeline that may be used to respond to an ARP request and a NTP request. This may ensure that incoming ARP requests or NTP requests may not be lost or dropped. As another example, apparatus 700 may include a data pipeline that may be used to respond to a NDP request and a NTP request.

Apparatus 700 may be able to prevent timestamp jitter greater than the transmit clock cycle of a Gigabit Ethernet when experiencing full traffic. Apparatus 700 may be implemented using a pipelined data path that may be an octet wide, such that an octet may be transmitted throughout apparatus 700. For example, octets may be transmitted to and from NDP module 605, IPV6 module 606, NTP module 608, UDP module 610, IPv4 module 612, ARP module 614, GMII 604, timestamp module 618, response module 620, transmit module 622, or the like.

Apparatus 700 may include a gigabit media independent interface (GMII) such as GMII 604. GMII may be connected to physical interface 104. GMII 604 may provide an interface between a media access control (MAC) and a physical layer. GMII 604 may be able to maintain a 1000 Mbits/s data rate and may be implemented using an eight-bit data interface. GMII 604 may be clocked at 125 MHz. GMII 604 may receive timing requests (e.g. NTP requests, PTP requests, etc.). and/or address resolution request (e.g. ARP requests, NDP requests, etc.). from physical interface 104. For example, GMII 604 may receive NTP and/or ARP requests from physical interface 104. GMII 604 may be able to receive data from physical interface 104 in a physical format and may convert that data into a GMII format.

NDP module 605 may be used by apparatus 700 to process a NDP request. NDP module 605 may receive NDP data such as a NDP header, from GMII 604. For example, NDP module 605 may receive an octet from GMII 604, which may be for a NDP header. NDP module 504 may verify the NDP header and may notify response module 620 whether the NDP header may be valid or invalid. For example, NDP module 605 may verify if the NDP data may be well formed such that the NDP header may be used to generate a NDP response.

If NDP module 605 determines that the NDP header may not be valid, apparatus 700 may determine that the NDP request may be invalid and may not generate a response. If NDP module 605 determines that the NDP header may be valid, the NDP processing device may determine that the NDP request may be valid and may generate a response. For example, the NDP processing device may generate a NDP response when NDP module 605 determines that the NDP header may be valid.

IPv6 module 606 may be used by apparatus 700 to process an NTP request or an NDP request that may be in an IPv6 format. IPv6 module 606 may receive data such as an IPv6 header, from GMII 604. For example, IPv6 module 606 may receive an octet from GMII 604, which may be for an IPv6 header. IPv6 module 606 may verify the IPv6 header and may notify response module 620 whether the IPv6 header may be valid or invalid. For example, IPv6 module 606 may verify if the IPv6 header may be well formed such that the IPv6 header may be used to generate a NTP response or an ARP response. As another example, IPv6 module 606 may verify the IPv6 header against a checksum for the IPv6 header. The checksum for the IPv6 header may be included within the IPv6 header and may be retrieved by IPv6 module 606.

If IPv6 module 606 determines that the IPv6 header is valid, then apparatus 700 may determine that the NTP request or ARP request may be valid and may generate a response. For example, NTP IPv6 module 606 may determine that the IPv6 header for a NTP request may be valid. NTP IPv6 606 may notify response module 620 that the NTP request may be in the IPv6 format and that the IPv6 header for the NTP response may be valid. Response module 620 may generate a NTP response using the IPv6 header.

If IPv6 module 606 determines that the IPv6 header may not be valid, then apparatus 700 may determine that the NTP request or ARP request is invalid and may not generate a response. For example, IPv6 606 may determine that the IPv6 header for an ARP request may not be well formed and may be invalid. NTP IPv6 606 may notify response module 620 that the ARP request may be in the IPv6 format and that the IPv6 header for the ARP request may be invalid. When notified that the IPv6 header may be invalid, response module 620 may not generate an ARP response.

NTP module 608 may be used by apparatus 700 to process a NTP request. NTP module 608 may receive NTP data, such as a NTP header, from GMII 604. For example, NTP module 608 may receive an octet from GMII 604, which may before a NTP header. NTP module 608 may verify the NTP header and may notify response module 620 whether the NTP header may be valid or invalid. For example, NTP module 608 may verify if the NTP header may be well formed such that the NTP header may be used to generate a NTP response. As another example, NTP module 608 may verify the NTP header using a cryptosum for the NTP header. NTP module 608 may calculate the cryptosum using one or more fields from the NTP header such as a leap warning indicator field, a version number field, a stratum field, a poll interval field, a precision field, or the like. As another example, NTP module 608 may verify the NTP header by authenticating the NTP header using a key identifier, an algorithm identifier, and/or a message hash from the NTP header.

If NTP module 608 determines that the NTP header is not valid, apparatus 700 may determine that the NTP request may be invalid and may not generate a response. If NTP module 608 determines that the NTP header may be valid, then apparatus 700 may determine that the NTP request may be valid and may generate a response. For example, apparatus 700 may generate a NTP response when NTP module 608 determines that the NTP header may be valid.

UDP module 610 may be used by apparatus 700 to process an NTP request, which may include a UDP header. UDP module 610 may receive data, such as a UDP header, from GMII 604. For example, UDP module 610 may receive an octet from GMII 604, which may be for an UDP header. UDP module 610 may verify the UDP header and may notify response module 620 whether the UDP header may be valid or invalid. For example, UDP module 610 may verify if the UDP header may be well formed such that the UDP header may be used to generate a NTP response. As another example, UDP module 610 may verify the UDP header against a checksum for the UDP header. The checksum for the UDP header may be included within the UDP header and may be retrieved by UDP module 610.

If UDP module 610 determines that the UDP header is valid, then apparatus 700 may determine that the NTP request may be valid and may generate a response. For example, UDP module 610 may determine that the UDP header for a NTP request may be valid. UDP module 610 may notify response module 620 that the NTP request may include UDP data and may notify response module 620 that the UDP header may be valid. Response module 620 may generate a NTP response using the UDP header.

If UDP module 610 determines that the UDP header may not be valid, then apparatus 700 may determine that the NTP request may be invalid and apparatus 700 may not generate a response. For example, UDP module 610 may determine that the UDP header may not be well formed and may be invalid and may notify response module 620 that the UDP header may be invalid. When notified that the UDP header may be invalid, response module 620 may not generate an NTP response.

IPv4 module 612 may be used by apparatus 700 to process an NTP request or an ARP request that may be in an IPv4 format. IPv4 module 612 may receive data, such as an IPv4 header, from GMII 604. For example, IPv4 module 612 may receive an octet from GMII 604, which may be for an IPv4 header. IPv4 module 612 may verify the IPv4 header and may notify response module 620 whether the IPv4 header may be valid or invalid. For example, IPv4 module 612 may verify if the IPv4 header may be well formed such that the IPv4 header may be used to generate a NTP response or an ARP response. As another example, IPv4 module 612 may verify the IPv4 header against a checksum for the IPv4 header. The checksum for the IPv4 header may be included within the IPv4 header and may be retrieved by IPv4 module 612.

If IPv4 module 612 determines that the IPv4 header is valid, then apparatus 700 may determine that the NTP request or ARP request may be valid and may generate a response. For example, NTP IPv4 module 612 may determine that the IPv4 header for a NTP request may be valid. NTP IPv4 612 may notify response module 620 that the NTP request may be in the IPv4 format and that the IPv4 header for the NTP response may be valid. Response module 620 may generate a NTP response using the IPv4 header.

If IPv4 module 612 determines that the IPv4 header may not be valid, then apparatus 700 may determine that the NTP request or ARP request is invalid and may not generate a response. For example, IPv4 612 may determine that the IPv4 header for an ARP request may not be well formed and may be invalid. NTP IPv412 may notify response module 620 that the ARP request may be in the IPv4 format and that the IPv4 header for the ARP request may be invalid. When notified that the IPv4 header may be invalid, response module 620 may not generate an ARP response.

ARP module 614 may be used by apparatus 700 to process an ARP request. ARP module 614 may receive ARP data, such as an ARP header, from GMII 604. For example, ARP module 614 may receive an octet from GMII 604, which may be for an ARP header. ARP module 614 may verify the ARP header and may notify response module 620 whether the ARP header may be valid or invalid. For example, ARP module 614 may verify if the ARP may be well formed such that the ARP header may be used to generate an ARP response. As another example, ARP module 614 may verify the ARP header using a cryptosum for the ARP header.

If ARP module 614 determines that the ARP header may not be valid, apparatus 700 may determine that the ARP request may be invalid and may not generate a response. If ARP module 614 determines that the ARP header may be valid, apparatus 700 may determine that the ARP request may be valid and may generate a response. For example, apparatus 700 may generate an ARP response when ARP module 614 determines that the ARP header may be valid.

Timestamp module 618 may be used by apparatus 700 to provide a timestamp. Timestamp module 618 may be a clock, a timestamp register, or the like. Timestamp module 618 may be disciplined such that it may provide an accurate timestamp. For example, timestamp module 618 may be disciplined such that it may be disciplined with a reference clock. As another example, timestamp module 618 may be a reference clock.

Response module 620 may receive data from GMII 604, which may be a NTP request, a PTP request, an ARP request, a NDP request, a combination thereof, or the like. For example, response module may use data received from NTP module 608 and/or ARP module 614 to determine whether the data from GMII 604 may be a NTP request or an ARP request.

Response module 620 may generate a NTP response. For example, response module 620 may receive a NTP request via GMII 604. Response module 620 may verify whether the NTP request may be valid using, for example, data from IPv6, NTP module 608, UDP module 610, and/or IPv4. If the NTP request is valid, response module 620 may generate a NTP response such as NTP response 530. Response module 620 may set the destination MAC address of the NTP response to the source MAC address of the NTP request. Response module 620 may set the source MAC address of the NTP response to the destination MAC address of the NTP request, or may set the MAC address of the NTP response to the MAC address of apparatus 700. The Ethertype of the NTP response may be set to the Ethertype of the NTP request. The source IP address of the response may be set to the destination IP address of the NTP request, or may be set to the IP address of apparatus 700. The destination address of the NTP response may be set to the source IP address of the NTP request. Response module 620 may calculate an IP checksum using the source IP address of the NTP response and/or the destination IP address of the NTP response. The IP checksum may be included in the NTP response. Response module 620 may set the source port of the NTP response to the destination port of the NTP request. Response module 620 may set the destination port of the NTP response to the source port of the NTP request. Response module 620 may generate a UDP checksum using the source port of the NTP response and the destination port of the NTP response. Response module 620 may include the UDP checksum in the NTP response. Response module 620 may set the mode of the NTP response to the mode of the NTP request. Response module 620 may include a reference timestamp, an originate timestamp, a transmit timestamp, and a receive timestamp in the NTP response.

Response module 620 may determine a receive timestamp and may include the receive timestamp in a NTP response. The receive timestamp may indicate when apparatus 700 may have received the NTP request. For example, Response module 620 may receive the NTP request. Response module 620 may determine a timestamp from timestamp module 618 and may set a receive timestamp for a NTP response as the determined timestamp. The determined timestamp may reflect when response module 620 may have received the NTP request. The determined timestamp may include a time offset that may account for a data processing delay such as the time that elapsed while determining a time stamp, the time that elapsed while retrieving a timestamp, the time that elapsed for the NTP request to travel to response module 620, a combination thereof, or the like. For example, the response module 620 may be able to determine time amount of time that may have elapsed from between when a request (e.g. an ARP request, a NTP request, a PTP request, a NDP request, or the like) was received by physical interface 104 and when the request was received by response module 620. Response module 620 may set a time offset to the determined amount of time. Response module 620 may retrieve a timestamp that may reflect a current time, may determine a receive timestamp by subtracting the time offset from the current time, and may include the receive timestamp in an NTP response.

Response module 620 may determine a transmit timestamp and may include the transmit timestamp in a NTP response. The transmit timestamp may indicate when the NTP response may send by apparatus 700. Response module 620 may determine a timestamp from timestamp module 618 and may set the determined timestamp as a transmit timestamp. The determined timestamp may reflect the when apparatus 700 may transmit the NTP response. The determined timestamp may include a time offset that may account for a data processing delay such as the time that elapsed while determining a timestamp, the time that may elapse before the response may be sent, the time that may elapse while sending the response, the time that may elapse while the NTP response may travel to physical interface 104 via transmit module 622, a combination thereof, or the like. For example, response module 620 may be able to determine that n number of clock cycles may occur between when a response is sent to be transmitted and the when the response is transmitted. This may allow response module 620 to determine a transmit timestamp that may reflect when a response may be sent before the response is sent. Response module 620 may use the determined n number of clock cycles to calculate a time offset. Response module 620 may determine a transmit timestamp by adding the time offset to a timestamp retrieved from timestamp module 618. Response module 620 may include the transmit timestamp within the response to indicate when the response may be sent.

Transmit module 622 may transmit a response such as a NTP response, an ARP response, a NDP response, a PTP response, or the like. For example, transmit module 622 may transmit an NTP response to a device, which may be the device that sent the NTP request, via GMII 604 and physical interface 104.

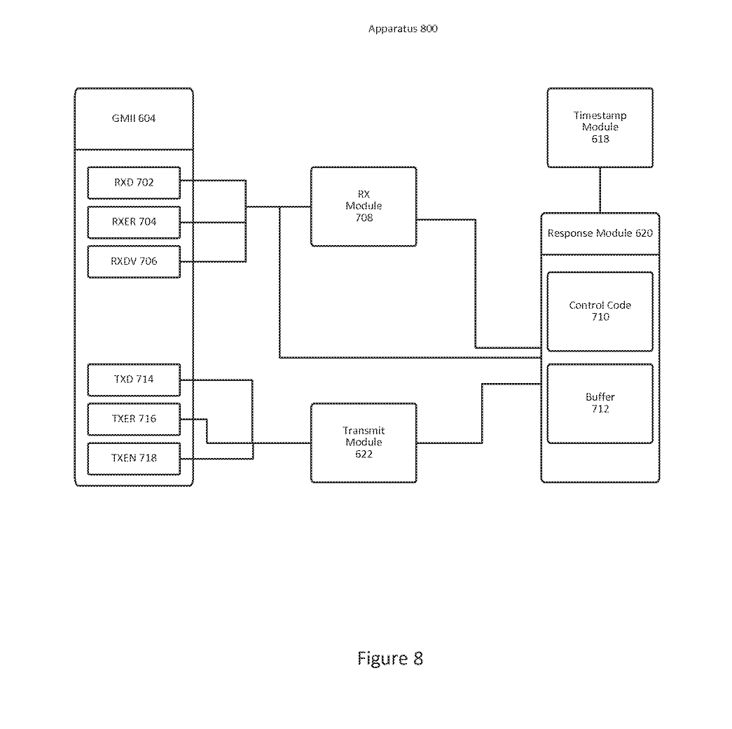

FIG. 8 illustrates an example apparatus for creating timestamps to be used for a timing response such as a NTP response, a PTP response, or the like. Apparatus 800 may be part of a NTP processing device such as NTP processing device 100. Apparatus 800 may be used to provide a hardware based NTP server and may be able to generating timing responses at a line rate throughput. For example, apparatus 800 may be able to receive timing requests at line rate throughput via Gigabit Ethernet, may be able to generate timing responses at line rate throughput, and may be able to transmit timing requests at line rate throughput via Gigabit Ethernet. Apparatus 700 may be able to process timing requests (e.g. PTP requests, NTP requests, etc.) and/or address resolution request (e.g. ARP requests, NDP requests, etc.) using the same data path. Apparatus 700 may be capable of processing timing requests and/or address resolution requests at line rate throughput without overflowing a buffer, without dropping a packet, a combination thereof, or the like.

RX module 708 may be used for processing and/or verifying a request such as a NTP request, a PTP request, an ARP request, a NDP request, a combination thereof, or the like. RX module 708 may include a number of modules such as NDP module 605, IPv6 module 606, NTP module 608, UDP module 610, IPv4 module 612, ARP module 614, a combination thereof, or the like. RX module 708 may receive data from GMII 604. For example, RX module 708 may receive data via RXD 702, may receive a signal that may indicate an error in the data via RXER 704, may receive a data valid signal from RXDV 706, or a combination thereof. RX module 708 may determine whether data received from GMII 604 may be a timing requests such as a NTP request or an address resolution request such as an ARP request. RX module may notify response module 620 what type of response may have been received from GMII interface 604. For example, RX module 708 may notify response module 620 that a NTP request may have been received.

RX module 708 may receive a NTP request from GMII 604. RX module 708 may retrieve a NTP header from the NTP request, may verify the NTP header, and may notify response module 620 whether the NTP header may be valid or invalid. For example, RX module 708 may verify if the NTP request may be well formed such that the NTP request may be used to generate a NTP response. As another example, RX module 708 may verify the NTP request using a cryptosum that may be calculated using a NTP header for the NTP request. As another example, RX module 708 may authenticate the NTP request by using a key identifier, an algorithm identifier, and/or a message hash from a NTP header from the NTP request.

If RX module 708 determines that the NTP request is not valid, RX module 708 may notify response module 620 that the NTP request may not be valid and response module 620 may not generate a NTP response. If RX module 708 determines that the NTP request may be valid, RX module 708 may notify response module 620 that the NTP may be valid and response module 620 may generate a NTP response.

RX module 708 may receive an ARP request from GMII 604. RX module 708 may verify the ARP request and may notify response module 620 whether the ARP request may be valid or invalid. For example, ARP module 614 may verify if the ARP request may be well formed such that the ARP request may be used to generate an ARP response. As another example, RX module 708 may verify the ARP response using a cryptosum. ARP module 614 may calculate the cryptosum using one or more fields from the ARP request.

If RX module 708 determines that the ARP request may not be valid, RX module 708 may notify response module 620 that the ARP request may not be valid, and response module 620 may not generate an ARP response. If RX module 708 determines that the ARP request may be valid, RX module 708 may notify response module 620 that the ARP request may be valid, and response module 620 may generate an ARP response.

Response module 620 may receive a NTP request from GMII 604 may generate a NTP response. Response module 620 may include control code 710 and buffer 712. Control code 710 may be used to generate values for a NTP response that may be stored in buffer 712, which may be a pingpong buffer. The values created by control code 710 and stored within buffer 712 may be used to generate a NTP response.

Control code 710 may verify whether a NTP request may be valid using, for example, data from RX module 708. If the NTP request is valid, control code may generate and/or determine a number of values that may be used to generate a NTP response and may store values in buffer 712. The values for the NTP response may include a destination MAC address, an Ethertype, a destination IP address, a UDP source port address, a UDP destination port address, an operating mode, a reference timestamp, a originate timestamp, a transmit timestamp, a receive timestamps, a combination thereof, or the like.

Control code 710 may use the NTP request to generate values to be used for the NTP response. Control code 710 may set a destination MAC address for the NTP response to the source MAC address of the NTP request. This may allow the NTP response to be sent to the MAC address of the device that sent the NTP request. Control code 710 may set the Ethertype for the NTP response to the Ethertype of the NTP request. This may ensure that the same Ethertype is used for both the NTP request and the NTP response. Control code 710 may set the destination IP address for the NTP response to the source IP address of the NTP request. This may allow the NTP response to be received sent to the IP address of the device that sent the NTP request. Control code 710 may set the UDP source port address for the NTP response to the UDP destination port address of the NTP request. Control code 710 may set the UDP destination port address for the NTP response to the UDP source port address of the NTP request. This may allow the NTP response to be sent to the UDP port address that may have been used to send the NTP request. Control code 710 may set the operating mode for the NTP response to the operating mode of the NTP response. This may ensure that the same operating mode may be used for both the NTP request and the NTP response. Control code 710 may place a reference timestamp, a originate timestamp, a transmit timestamp, and a receive timestamp for the NTP response in buffer 712.

Control code 710 may determine a receive timestamp for the NTP request and may include the receive timestamp in buffer 712. The transmit timestamp may indicate when the NTP request may have been received. The transmit timestamp may be determined using a timestamp from timestamp module 618. For example, control code 710 may receive a NTP request. Control code 710 may determine a timestamp from timestamp module 618 and may set a receive timestamp for a NTP response as the determined timestamp. The determined timestamp may reflect when response module 620 may have received the NTP request. The determined timestamp may include a time offset that may account for a data processing delay such as the time that elapsed while determining a timestamp, the time that elapsed while retrieving a timestamp, the time that elapsed for the NTP request to travel to control code 710, a combination thereof, or the like. For example, control code 710 may be able to determine the amount of time that may have elapsed from when a request was received by GMII 604 and when the request was received by control code 710. Control code 710 may set a time offset to the determined amount of time. Control code 710 may retrieve a timestamp that may reflect a current time, may determine a receive timestamp by subtracting the time offset from the current time, and may include the receive timestamp in an NTP response.

Control code 710 may determine a transmit timestamp for the NTP response and may store the transmit timestamp in buffer 712. The transmit timestamp may indicate when the NTP response may be sent. Control code 710 may determine a timestamp from timestamp module 618 and may set the determined timestamp as transmit timestamp. The determined timestamp may reflect the NTP device and may transmit the NTP response. The determine timestamp may include a time offset that may account for a data processing delay such as the time that elapsed while determining a timestamp, the time that may elapse before the NTP response may be sent, the time that may elapse while sending the response, a combination thereof, or the like. For example, control code 710 may be able to determine that n number of clock cycles may occur between when a response is sent to be transmitted and when the response is transmitted. This may allow control code 710 to determine a transmit timestamp that may reflect when a NTP response may be sent before the NTP response is sent. Control code 710 may use the n number of clock cycles to calculate a time offset. Control code 710 may determine a transmit timestamp by adding the time offset to a timestamp retrieved from timestamp module 618. Control code 710 may include the transmit timestamp within the response to indicate when the NTP response may be sent.

Control code 710 may determine number of values that may be used to generate an ARP response, which may be stored in buffer 712. The values may be determined using, for example, an ARP response. The values may include a hardware type (HTYPE), a protocol type (PTYPE), a hardware length (HLEN), a protocol length (PLEN), an operation, a sender hardware address (SHA), a sender protocol address (SPA), a target hardware address (THA), a target protocol address (TPA), or the like. The HTYPE may indicate the network protocol type that may be used. The PTYPE may indicate an internetwork protocol for which an ARP response may be intended. The HLEN may be a length of a hardware address. The PLEN may be the length of an address that may be used in an upper layer protocol. The operation may indicate that the ARP request is a request. The SHA may indicate the media address of a sender, which may be apparatus 800. The SPA may indicate address of a sender, which may be apparatus 800. The THA may be the media address of an intended receiver, which may be the device that may receive the ARP response. The TPA may be the network address of an intended receiver, which may be device that may receive the ARP response.

Transmit module 622 may transmit a response such as a NTP response, an ARP response, a NDP response, a PTP response, or the like. For example, transmit module 622 may transmit an NTP response to a device, which may be the device that sent the NTP request, via GMII 604. Transmit module 622 may send data via TXD 714, may send a signal that may indicate an error in the data via TXER 716, and may send a transmit enable signal via TXEN 718, or a combination thereof.

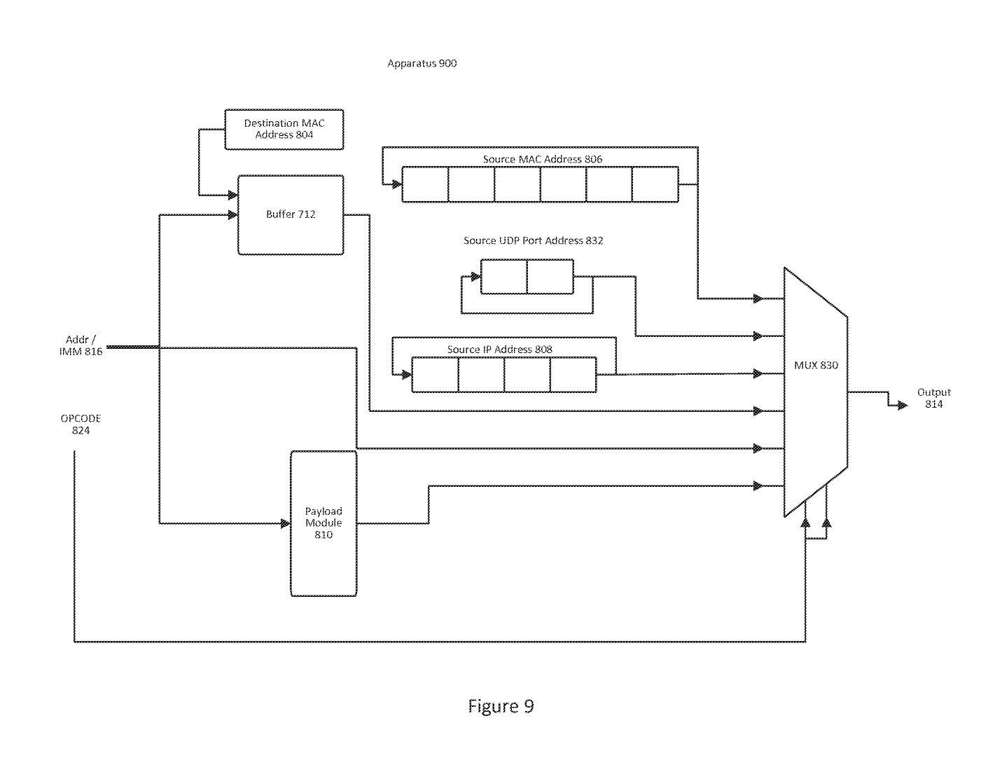

FIG. 9 illustrates an example apparatus for generating an address resolution response (e.g. an ARP response, a NDP response, etc.) or a timing response (e.g. an NTP response, a PTP response, etc.). For example, apparatus 900 may be used to generate a NTP response and/or an ARP response. Apparatus 900 may be part of a NTP processing device such as NTP processing device 100.

Apparatus 900 may include buffer 712, destination MAC address 804, source MAC address 806, source IP address 808, multiplexer (MUX) 830, and payload module 810. Buffer 712 may be used to store data that may be used to generate a NTP response or an ARP response.

Apparatus 900 may generate a NTP response or an ARP response that may include a destination MAC address. The destination Mac address may be the MAC address for a device that may receive the NTP response or the ARP response. The destination MAC address may be stored in destination MAC address 804 and may be loaded in to buffer 712. An operation code (opcode) may be sent via opcode 824 to instruct MUX 830 to select data from buffer 712. An instruction may be sent via address/IMM to buffer 712 to send the destination MAC address to MUX 830. MUX 830 may send destination MAC address via output 814 such that the destination MAC address may be include in a NTP response or an ARP response.

Apparatus 900 may generate a NTP response or an ARP response that may include a source MAC address. The source MAC address may be the MAC address of the NTP processing device that may be used to send the NTP response or the ARP response. The source MAC address may be stored in source MAC address 806, which may be a shift register. An opcode may be sent via opcode 824 to instruct MUX 830 to select data from source MAC address 806. Source MAC address 806 may shift bits into MUX 830 and MUX 830 may pass the bits to output 814 such that the source MAC address may be included in a NTP response or an ARP response.

Apparatus 900 may generate a NTP response or an ARP response that may include an Ethertype. For example, an Ethertype may be retrieved from a response. The Ethertype may be sent to MUX 830 via Addr/IMM 816. An opcode may be sent via opcode 824 to instruct MUX 830 to select data from Addr/IMM 816, which may include the Ethertype. MUX 830 may pass the Ethertype data to output 814 such that the Ethertype may be included in a NTP response, a ARP response, a NDP response, or the like.

Apparatus 900 may generate a NTP response or an ARP response that may include an operating mode. The operating mode may be an association mode, a client/server mode, a symmetric active/passive mode, a broadcast mode, an IP multicast support mode, a multicasting mode, a manycasting mode, a burst mode, or the like. The operating mode may indicate the operating mode used while generating the NTP or ARP response.

Apparatus 900 may generate a NTP response or an ARP response that may include a source IP address. The source IP address may be the IP address of the NTP processing device that may be used to send the NTP response or the ARP response. The source IP address may be stored in source IP address 808, which may be a shift register. An opcode may be sent via opcode 824 to instruct MUX 830 to select data from source IP address 808. Source IP address may shift bits into MUX 830 and MUX 830 may pass the bits to output 814 such that the source IP address may be included in a NTP response, a ARP response, a NDP response, or the like.

Apparatus 900 may generate a NTP response or an ARP response that may include a destination IP address. The destination IP address may be the IP address for a device that may receive the NTP response or the ARP response. The destination IP address may be stored in Buffer 712. An opcode may be sent via opcode 824 to instruct MUX 830 to select data sent from buffer 712. An instruction may be sent via address/IMM to buffer 712 to send the destination IP address to MUX 830. MUX 830 may send the destination IP address via output 814 such that the destination IP address may be include in a NTP response or an ARP response.

Apparatus 900 may generate a NTP response that may include a UDP destination port address. The UDP destination port address may be the UDP port address used by a device to receive the response sent by the NTP processing device. The UDP destination port address may be stored in buffer 712. An opcode may be sent via opcode 824 to instruct MUX 830 to select data sent from buffer 712. An instruction may be sent via address/IMM to buffer 712 to send the UDP destination port address to MUX 830. MUX 830 may send the UDP destination port address via output 814 such that the UDP destination port address may be include in a NTP response.

Apparatus 900 may generate a NTP response that may include a UDP source port address. The UDP source port address may be the UDP port address used by the NTP processing device to send a response. The UDP source port address may be stored in source UDP port address 832, which may be a shift register. An opcode may be sent via opcode 824 to instruct MUX 830 to select data sent from source UDP port address 832. MUX 830 may receive the source UDP port address and may send the UDP source port address via output 814 such that the UDP source port address may be include in a NTP response.

Apparatus 900 may generate a NTP response or an ARP response that may include a checksum such as an IP checksum, a UDP checksum, or the like. Payload module 810 may generate an IP checksum that may be used to verify IP address that may be included in a NTP response, a ARP response, a NDP response, or the like. For example, a device that may receive a NTP response may use the IP checksum within the NTP response to verify IP address that may be included in the NTP. Payload module 810 may generate a UDP checksum that may be used to verify UDP port addresses that may be included in an NTP response or an ARP response. For example, a device that may receive a NTP response may use the UDP checksum within the NTP response to verify the UDP port address that may be included within the NTP response. An opcode may be sent via opcode 824 to instruct MUX 830 to select data sent from payload module 810. An instruction may be sent via address/IMM to payload module 810 to send the IP checksum and/or the UDP checksum to MUX 830. MUX 830 may send the checksum via output 814 such that the IP checksum and/or the UDP checksum may be included in a NTP response, a ARP response, a NDP response, or the like.

Apparatus 900 may generate a NTP response that may include NTP that may include a timestamp. Payload module 810 may store one or more timestamps that may be used for the NTP response. The timestamps may include a reference timestamp, an originate timestamp, a transmit timestamp, and a receive timestamp. Payload module 810 may receive instructions via address/immediate (IMM) 816 to retrieve a timestamp and send the timestamp to MUX 830. An opcode may be sent via opcode 824 to instruct MUX 830 to select data from payload module 810. MUX 830 may send the data from payload module 810 to output 814 such that the reference timestamp, the originate timestamp, the transmit timestamp, and/or the receive timestamp may be included in the NTP response.

What is claimed:

1. An apparatus comprising:
a processor configured to:
receive a timing request at a line rate;
calculate a transmit timestamp that indicates when a timing response will be sent;
generate the timing response at the line rate such that an incoming data packet is prevented from being dropped, wherein the timing response includes the transmit timestamp; and
send the timing response at the time indicated by the transmit timestamp.

2. The apparatus of claim 1, wherein the processor is configured to generate a timing response at the line rate such that a buffer is prevented from over flowing.

3. The apparatus of claim 1, wherein the timing response further includes a receive timestamp that indicates when the timing request was received.

4. The apparatus of claim 1 wherein the timing request is a first timing request and wherein the incoming data packet includes a second timing request.

5. The apparatus of claim 1, wherein the timing request is a first timing request, and wherein the incoming data packet includes an address resolution request.

6. The apparatus of claim 1, wherein the line rate is the rate at which data is sent or received over a physical connection.

7. An apparatus comprising:
a processor configured to:
calculate a transmit timestamp that indicates when a timing response will be sent;
generate the timing response to discipline a clock using a data path that can be used to generate an address response; and
send the timing response at the time indicated by the transmit timestamp.

8. The apparatus of claim 7, wherein the timing response is a network timing protocol (NTP) response or a precision timing protocol (PTP) response.

9. The apparatus of claim 8, wherein the address response is an address resolution protocol (ARP) response or a neighbor discovery protocol (NDP) response.

10. The apparatus of claim 7, wherein the data path can prevent an incoming packet from being dropped while operating at a line rate.

11. The apparatus of claim 7, wherein the data path can prevent a buffer receiving an incoming packet from overflowing.

12. The apparatus of claim 7, wherein the line rate is the rate at which data is sent or received over a physical connection.

13. An apparatus comprising:
a processor configured to:
receive a request to discipline a clock;
calculate a transmit timestamp that indicates when a response will be sent; and
generate a response at a line rate such that timestamp jitter greater than a clock cycle is prevented, wherein the response can be used to discipline the clock.

14. The apparatus of claim 13, wherein the processor is further configured to send the response.

15. The apparatus of claim 13, wherein the response includes a receive timestamp that indicates when the request was received.

16. The apparatus of claim 15, wherein the response include an originate timestamp that indicates when the clock was last disciplined.

17. The apparatus of claim 16, wherein the response includes a reference timestamp that is a timestamp from a reference clock.

18. The apparatus of claim 13, wherein the line rate is the rate at which data is sent or received over a physical connection.

19. The apparatus of claim 13, wherein the transmit timestamp is a cycle accurate timestamp.

20. The apparatus of claim 13, wherein the processor is configured to generate the response using a data path that can be used to generate an address response.
